(19) United States
(12) Patent Application Publication
(10) Pub. No.: US 2018/0357721 A1
(43) Pub. Date: Dec. 13, 2018

(54) SYSTEM AND METHOD FOR PROVIDING VEHICLE INSURANCE PREMIUM REFUNDS

(71) Applicant: ANDRE PHILIPPE GATION, Miami, FL (US)

(72) Inventor: ANDRE PHILIPPE GATION, Miami, FL (US)

(21) Appl. No.: 15/496,508

(22) Filed: Apr. 25, 2017

(51) Int. Cl. G06Q 40/08; G07C 5/00; G07C 5/08

(52) U.S. Cl. CPC G06Q 40/08; G07C 5/085; G07C 5/008

(57) ABSTRACT

The present invention generally relates to a system and method for providing vehicle insurance premium refunds. Specifically, a vehicle device is connected to a vehicle to monitor, store, and transmit vehicle information to a remote application server. The application server calculates the total amount of time a vehicle is not in use for a selected period and compares that with preset insurance premium information to determine if the user qualifies for a refund amount. If a user qualifies for a refund amount, the application server may automatically provide the user with the refund amount.

### BACKGROUND OF THE INVENTION

### Field of the Invention

The present invention generally relates to a system and method for providing vehicle insurance premium refunds. Specifically, a vehicle device is used to determine a total amount of time a vehicle is not in operation during a select period and determines a refund amount by comparing it against preset vehicle insurance premium data.

### Description of the Related Art

Determining the price of a vehicle insurance policy typically involves checking the applicant's driving history and record, age, gender, address, zip code, etc. and referencing the type of vehicle the applicant is applying for and the type of insurance required on the vehicle. Such information may place the applicant in one of many broad categories of risk assessment. However, when utilizing broad data and categories, applicants are not always treated equal. For example, one person that does not drive his or her vehicle frequently will often still have to pay the same insurance premium amount as a person that drives his or her vehicle daily.

Thus, there exists a need for a system and method that provides for vehicle insurance premium refunds based on actual data of the insured vehicle while the vehicle is being driven that can be implemented at a low cost, are relatively easy to use, and automatically provide a refund amount to certain drivers based on a total amount of time the vehicle was not in use during a select period.

### SUMMARY OF THE INVENTION

The present invention is generally directed to providing vehicle insurance premium refunds. Accordingly, one embodiment of the present invention is directed to a system for vehicle insurance refunds which may comprise a vehicle device removably connected to the vehicle and configured to monitor and store certain vehicle information from the vehicle's computer. Additionally, the vehicle device is communicably connected to an insurance company's remote application server and configured to transmit the vehicle information to the application server.

The application server may comprise a special purpose or general purpose computer structured and configured to facilitate and/or direct vehicle information between the vehicle's computer and the vehicle device. Accordingly, the vehicle device allows a user to transmit vehicle information to the application server via the vehicle device in the hopes of being awarded a refund for non-use. As such, the application server is configured to calculate a total amount of time the vehicle was not in use during the year or other specific interval of time.

Further, the application server is configured to compare the total amount of time the vehicle was not in use with the user's preset vehicle insurance premium information stored on the application server to determine if the user qualifies for a refund amount. If the user qualifies for the refund amount, the application server will automatically provide the refund amount to the user.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a diagrammatic representation of an exemplary implementation environment for providing vehicle insurance premium refunds of the present invention.

FIG. 2 is a flow chart depicting steps of a method according to one embodiment of present invention.

Like reference numerals refer to like parts throughout the several views of the drawings.

### DETAILED DESCRIPTION OF THE PREFERRED EMBODIMENT

The present invention is directed to a system 100 and method for providing a refund of an unused portion of a user's prepaid insurance premium associated with a vehicle for a selected period, based on “non-use” of the vehicle during the selected period. Accordingly, based on preset vehicle insurance information, such as but not limited to, an user's driving history and record, age, gender, address, type of vehicle to be insured, etc., an insurance company may determine the prepaid vehicle insurance premium for the vehicle for the selected period. The present invention allows for a refund of the unused portion of the prepaid vehicle insurance premium based on actual data from the vehicle while the vehicle is being driven during the selected period. Further, the preset vehicle insurance information and the prepaid vehicle insurance premium for the selected period may be stored on the insurance company's application server 110, as described in greater detail below.

Accordingly, the system 100 includes a vehicle device 101 operatively connected to the vehicle and configured to detect the vehicle in an operative state. Further, when the vehicle is in the operative state, the vehicle device 101 is configured to monitor at least one data component associated with the vehicle. The operative state of the vehicle may include, but not limited to detecting: a key in the ignition; powering on of the vehicle; movement of the vehicle; or any combination thereof. The at least one data component of the vehicle may include, but not limited to: an amount of time the vehicle was driven; an amount of miles or kilometers the vehicle was driven; time of day the vehicle was driven; or any combination thereof.

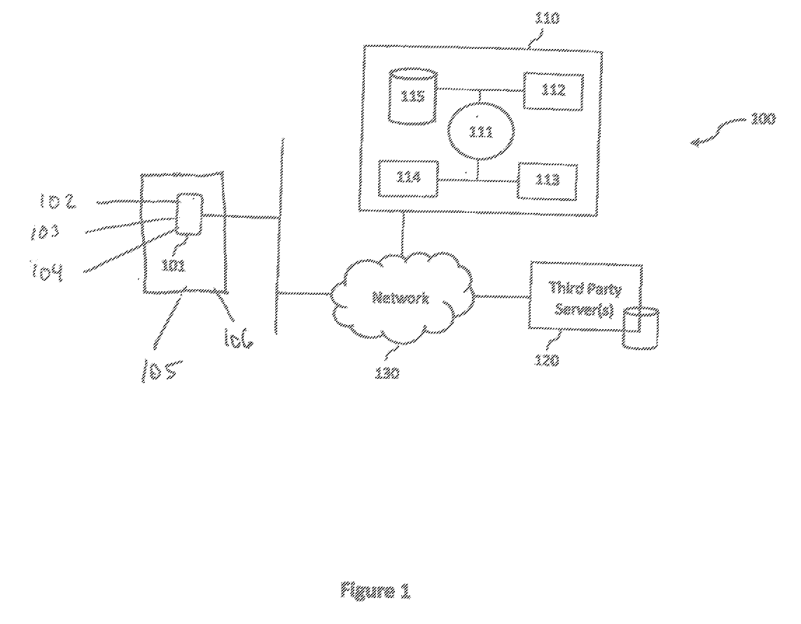

The vehicle device 101 includes sufficient structural and operative versatility to facilitate its use while connected to the vehicle. Accordingly, for purposes of clarity, the vehicle and the vehicle computer are referenced in FIG. 1 as 105 and 106 respectively. The vehicle device 101 may be connected to different ones of a plurality of vehicles 105 such as, but not limited to, cars, trucks, motorcycles, watercraft, motor homes, heavy machinery, etc. In addition, the vehicle device 101 may be removably connected to the vehicle 105.

In one embodiment, the vehicle device 101 may store the monitored at least one data component, as described in greater detail hereinafter. In another embodiment, the vehicle device 101 may monitor, store, and transmit the at least one data component associated with the vehicle 105 to a remote application server 110, such as the application server 110 of the insurance company that issued the insurance policy.

Additionally, the vehicle device 101 may be communicably connected to the application server 110 in accordance with the implementation of the system 100 as generally represented in FIG. 1. Accordingly, the system 100 of the present invention may comprise the vehicle device 101 communicably connected to the application server 110 over a network 130. One or more third party server(s) 120 may further be communicably connected to the application server 110 and the vehicle device 101 over the same network 130. For example, the third party server 120, such as a marketing company's server 120 may be configured to access certain data from the application server 110 and/or the vehicle device 101 in order to offer the user products or services based on the data.

The vehicle device 101 may comprise a computer or any other device or combination of circuits structured and configured to communicate with the vehicle 105, including the vehicle's computer 106. Additionally, the vehicle device 101 may comprise a computer to communicate with another device, computer, or the application server 110 over the network 130. As such, the vehicle device 101 may comprise a central processing unit or CPU 102, a memory module 103, and a wireless communication module 104 for transmitting the at least one data component associated with the vehicle 105 to the application server 110 and any third party server(s) 120 and stored applications and programs thereon.

As mentioned above, the vehicle device 101 may be configured to detect when the vehicle 105 is in the operative state. For example, the vehicle device 101 may detect the vehicle 105 is powered on or “turned on” as described in greater detail hereinafter. Further, the vehicle device 101 may be configured to monitor and store the at least one data component of the vehicle 105. As such, the vehicle device 101 may monitor and store the at least one data component of the vehicle 105 by communicating with the vehicle's computer 106. The memory module 103 of the vehicle device 101 may include device specific storage functionality such as local storage capable of storing certain vehicle 105 information. As such, the memory module 103 may be configured to store the at least one data component associated with the vehicle 105. The vehicle device 101 may store and transmit the monitored at least one data component associated with the vehicle 105 to the application server 110, so as to store and maintain the information remotely.

Transmission of the monitored at least one data component from the vehicle device 101 to the application server 110 may be initiated by an application or pre-installed software running on the vehicle device 101. More specifically, the vehicle device 101 may be programmed to transmit the monitored at least one data component to the application server 110 when the vehicle 105 is in the operative state. In one embodiment, the vehicle device 101 may be programmed to transmit the monitored at least one data component to the application server 110 based on a predetermined period of time. For example, the predetermined period of time that the vehicle device 101 may transmit the monitored at least one data component to the application server 110 may be every second, minute, hour, day, week, month, year, etc. Additionally, the vehicle device 101 may transmit the monitored at least one data component to the application server 110 automatically.

In order to determine the “non-use” of the vehicle 105 during the selected period, the vehicle device 101 may detect the vehicle in the operative state, and monitor and store the at least one data component associated with the vehicle 105. Additionally, the vehicle device 101 may transmit the monitored at least one data component to the application server 110 via the network 130. As illustrated, such communication will typically be accomplished via the wireless communication module 104 of the vehicle device 101 communicably connected to the application server 110.

As mentioned above, the vehicle device 101 may monitor and store the at least one data component of the vehicle 105 when the vehicle 105 is in the operative state. The operative state of the vehicle 105 may include the powering on or “turning on” the vehicle 105. For example, the vehicle device 101 may be configured to detect that the vehicle 105 has been powered on or “turned on”, at which point the vehicle device 101 may monitor and store the at least one data component of the vehicle 105. More specifically, when the vehicle device 101 detects that the vehicle 105 has been “turned on”, the vehicle device 101 may begin to monitor and store the at least one data component until the vehicle 105 has been subsequently powered off or “turned off”. The “turning on” of the vehicle 105 may include placing the vehicle 105 in a state of use, and the “turning off” of the vehicle 105 may include placing the vehicle 105 in a state of non-use.

The terms “application server” 110 and “third party server” 120 each refer to at least one computer having appropriate hardware and applications installed thereon for the provision of server services including functional services described herein. More specifically, the application server 110 and third party server(s) 120 may comprise general-purpose computers, specialized computers, or other hardware components structured and configured to receive, process, transmit, and store information to and from other devices. The application server 110 is further configured with executable or interpretable computer code that allows it to perform the processes described within this application.

For example, the application server 110 may comprise a general-purpose computer comprising a central processing unit (CPU) 111, which may be a single core or multi core processor, memory 114 (random-access memory, read-only memory, and/or flash memory) or primary memory for high-speed storage of executing programs, electronic storage unit 115 (e.g., hard disk, database) or secondary memory for storing data, communications interface 112 (e.g., network adapter) for communicating with other devices or computers over a network, and/or peripheral device(s) 113 in communication with the CPU 111 that enable input/output of the application server 110.

The application server 110 may implement the methodology of the present invention using any number of solution stacks (a set of software subsystems or components) known to an ordinary computer or web programmer skilled in the art. These solution stacks may include, without limitation, ZEND Server, APACHE Server, NODE.JS, ASP, PHP, Ruby, XAMPP, LAMP, WAMP, MAMP, WISA, LEAP, GLASS, LYME, LYCE, OpenStack, Ganeti, MEAN, MEEN, XRX, JAVASCRIPT and other past, present, or future equivalent solution stacks, or combinations thereof, known to those skilled in the art that allows a programmer to develop the method described within this application. The software stack might be implemented without third-party cloud platforms, for example using load balancing and virtualization software provided by Citrix, Microsoft, VMware, Map-Reduce, Google Filesystem, Xen, memory caching software such as Memcached and Membase, structured storage software such as MySQL, MariaDB, XtraDB, etc. and/or other appropriate platforms. Of course, these solution stacks may also be deployed in cloud platforms by using known development tools and server hosting services such as GitHub and Rackspace, as well as their equivalents.

The third party server(s) 120 may comprise any combination of hardware and software (code segments in any number of programmable, executable, or interpretable languages that support the functionality of the method described herein) configured to host and transmit items of an insurer. The third party server(s) 120 may be configured to communicate directly to the application server 110 via application programming interfaces or upon the request of an insurer.

The network 130 may comprise at least two computers in communication with each other, which may form a data network such as via LAN, WAN, Serial, Z-WAVE, ZIGBEE, RS-485, MODBUS, BACNET, the Internet, or combinations thereof. The connections may be facilitated over various wired and/or wireless mediums or any combination thereof including interconnections by routers and/or gateways. The network 130 may comprise additional hardware components and/or devices appropriate for facilitating the transmission and communication between the various systems and devices of the present invention, such as those directed to integrated authentication, quality control or to improve content delivery such as via a content delivery network (CDN).

Various aspects of the present invention may be thought of as “products” or “articles of manufacture” typically in the form of machine (or processor) executable code, interpretable code, and/or associated data that is carried on or embodied in a machine readable medium. Machine-executable code can be stored on an electronic storage unit, such memory (e.g., read-only memory, random-access memory, flash memory) or a hard disk, as described above.

All or portions of the software may at times be communicated through the communication networks. Such communications, for example, may enable loading of the software from one computer or processor onto another, for example, from a management server or host computer onto the computer platform of an application server, or from an application server onto a device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, tangible “storage” media, terms such as computer or machine “readable medium”, refer to any medium that participates in providing instructions to a processor for execution. Further, the term “non-transitory” computer readable media includes both volatile and non-volatile media, including RAM. In other words, non-transitory computer media excludes only transitory propagating signals per se, but includes at least register memory, processor cache, RAM, and equivalents thereof.

Therefore, a machine-readable medium, such as computer-executable code and/or related data structures, may take many forms, including but not limited to, a tangible storage medium, a carrier wave medium or physical transmission medium. Non-volatile storage media include, for example, optical, magnetic, or solid state disks, such as any of the storage devices in any computer(s) or the like, such as may be used to house the databases. Volatile storage media include dynamic memory, such as main memory of such a computer platform. Tangible transmission media may include coaxial cables, copper wire and fiber optics, communication buses. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

As mentioned above, the vehicle device 101 may be removably connected to the vehicle 105. More specifically, the vehicle device 101 may be removably connected to the vehicle's computer 106 in order to monitor and store desired vehicle 105 information, such as the at least one data component. Additionally, the vehicle device 101 may be communicably connected to the remote application server 110. As such, the vehicle device 101 may have the ability to communicate with the application server 110 in order to transmit the monitored at least one data component, via the network 130.

As shown, the application server 110 comprises a single location; however, it is within the scope and intent of the present invention that the application server 110 can comprise multiple locations, as can the various components thereof. As mentioned above, the application server 110 includes at least one computer processor and is structured to have sufficient processing and/or storing capabilities to manage the administration of relevant aspects of the system 100 in the intended manner, including, but not limited to, the storage, processing, and manipulation of the at least one data component associated with the vehicle 105. In one embodiment, other vehicle 105 information and/or user account information may be transmitted and/or received to/from the application server 110, such as various device data, settings, premises data, vehicle IDs, vehicle device IDs, user IDs, site specific information, including GPS data, etc. As such, the vehicle device 101 may be linked with the vehicle 105 and/or the user on the application server 110.

The application server 110 may calculate the non-use of the vehicle 105 during the selected period based on the at least one data component of the vehicle 105 for the corresponding selected period. The selected period may include one month, six months, one year, etc. More specifically, the application server 110 may compare the at least one data component with the preset vehicle insurance information for the selected period to determine if the user qualifies for the refund amount. Additionally, calculating or determining the “non-use” of the vehicle 105 during the selected period based on the at least one data component associated with the vehicle 105 may comprise using a proprietary calculating algorithm or procedure executed by the application server 110.

If the user qualifies for the refund amount, the application server 110 may automatically provide the user with the refund amount. In one embodiment, the refund amount may be provided by the application server 110 to the user via a physical check or electronic payment. In another embodiment, the refund amount may be provided to the user as a pre-payment or credit amount for a future period on the application server 110.

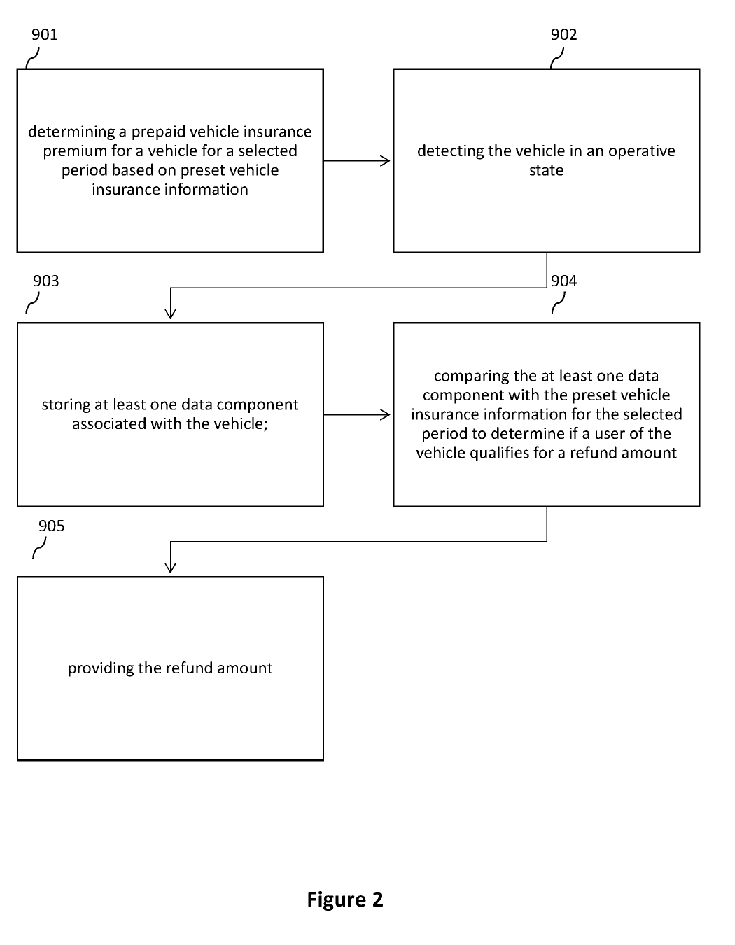

Drawing attention to FIG. 2, a method of the present invention may comprise determining a prepaid vehicle insurance premium for a vehicle for a selected period based on preset vehicle insurance information, as in 901. Next, at 902, the method of the present invention may comprise detecting the vehicle in an operative state. Next, at 903, the method of the present invention may comprise storing at least one data component associate with the vehicle. Next, at 904, the method of the present invention may comprise comparing the at least one data component with the preset vehicle insurance information for the selected period to determine if a user of the vehicle qualifies for a refund amount. Next, at 905, the method of the present invention may comprise providing the refund amount.

Individual components or elements of the system 100 and method may be used interchangeably. The order of the method or processes described above may be arranged in any combination in various embodiments. In some embodiments omitted.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A method for determining if a refund amount is necessary of a portion of a user's prepaid vehicle insurance premium for a selected period comprising:
determining the prepaid vehicle insurance premium for the selected period based on preset vehicle insurance information;
detecting the vehicle in an operative state;
storing at least one data component associated with the vehicle; and
comparing the at least one data component with the preset vehicle insurance information for the selected period to determine if the user qualifies for the refund amount.

2. The method of claim 1 wherein detecting the vehicle in an operative state comprises determining at least powering on the vehicle.

3. The method of claim 1 wherein the at least one data component associated with the vehicle comprises an amount of miles the vehicle was driven.

4. The method of claim 1 wherein the at least one data component associated with the vehicle comprises an amount of time the vehicle was driven.

5. The method of claim 1 wherein the at least one data component associated with the vehicle comprises time of day the vehicle was driven.

6. The method of claim 1 wherein the selected period comprises one year.

7. The method of claim 1 wherein the selected period comprises one month.

8. The method of claim 1 wherein the storing at least one data component comprises storing at least one data component for the selected period and configuring the at least one data component to be determinative of an amount of time the vehicle was not in use for the selected period.

9. A method for determining a refund amount of a portion of a user's vehicle insurance premium comprising:
detecting the vehicle in an operative state;
monitoring at least one data component associated with the vehicle;
transmitting the at least one monitored data component associated with the vehicle to an application server;
determining an amount of time the vehicle was not in use for a selected period based on the at least one data component associated with the vehicle for the corresponding selected period;
comparing the amount of time the vehicle was not in use for the selected period with preset vehicle insurance information associated with the vehicle for the corresponding selected period to determine if the user qualifies for the refund amount; and
storing the preset vehicle insurance information associated with the vehicle in a database of the application server.

10. The method of claim 9 wherein detecting the vehicle in an operative state comprises determining at least powering on the vehicle.

11. The method of claim 9 wherein the at least one data component associated with the vehicle comprises an amount of miles the vehicle was driven while in the operative state.

12. The method of claim 9 wherein the at least one data component associated with the vehicle comprises an amount of time the vehicle was driven while in the operative state.

13. The method of claim 9 wherein the at least one data component associated with the vehicle comprises time of day the vehicle was driven while in the operative state.

14. The method of claim 9 wherein the monitoring at least one data component associated with the vehicle comprises storing the at least one data component associated with the vehicle.

15. The method of claim 14 wherein storing the at least one data component associated with the vehicle to the application server comprises stored the stored at least one data component associated with the vehicle to the application server for a predetermined amount of time.

16. The method of claim 15 wherein the predetermined amount of time comprises one year.

17. The method of claim 9 further comprising automatically transmitting the at least one data component associated with the vehicle to the application server.

18. The method of claim 9 wherein the selected period comprises one year.

19. The method of claim 9 wherein the selected period comprises one month.

20. A system for determining a refund of a cost of a vehicle insurance premium, said system comprising:
a vehicle device operatively connected to the vehicle and configured to monitor and store at least one data component associated with the vehicle;
said vehicle device communicably connected to an application server via a communication network comprising:
a central processing unit;
a memory module;
a wireless communication module;
said application server comprises at least one database having prepaid vehicle insurance premium associated with the vehicle.

21. The system as recited in claim 20 wherein said vehicle device is configured to transmit the at least one data component associated with the vehicle to said application server, via said communication network, at a predetermined amount of time.

22. The system as recited in claim 20 wherein said vehicle device is configured to transmit the at least one data component associated with the vehicle to said application server, via said communication network, automatically.

23. The system as recited in claim 20 wherein said application server is configured to determine an amount of time the vehicle was not in use during a selected period.

24. The system as recited in claim 23 wherein said application server is configured to compare the amount of time the vehicle was not in use during the selected period with preset insurance information for the corresponding selected period to determine a refund amount.
